(19) United States
(12) Patent Application Publication
(10) Pub. No.: US 2026/0120480 A1
(43) Pub. Date: Apr. 30, 2026

(54) SYSTEMS AND METHODS FOR SIGN DETECTION AND CLASSIFICATION IN AUTONOMOUS VEHICLES

(71) Applicant: Torc Robotics, Inc., Blacksburg, VA (US)

(72) Inventor: Bhavi Bharat Kotha, Blacksburg, VA (US)

(21) Appl. No.: 18/930,654

(22) Filed: Oct. 29, 2024

(51) Int. Cl. G06V 20/58; G06V 10/25; G06V 10/26; G06V 10/764; G06V 10/774; G06V 10/82

(52) U.S. Cl. CPC G06V 20/582; G06V 10/25; G06V 10/26; G06V 10/764; G06V 10/774; G06V 10/82

(57) ABSTRACT

Systems and methods for detecting and classifying streets signs include at least one processor in communication with at least one memory device. The at least one processor is programmed to receive at least one first sensor data, detect at least one region of interest containing a street sign based on the first sensor data, extract the at least one region of interest data from the first sensor data, and classify the street sign based on the region of interest data. Detecting at least one region of interest includes detecting the at least one region of interest by comparing measured dimensions of the at least one region of interest to predefined dimensions of the street sign at a depth corresponding to the at least one region of interest. Classifying includes outputting at least one of a sign type or sign value.

### TECHNICAL FIELD

The field of the disclosure relates generally to autonomous vehicles and, more specifically, street sign detection and classification by an autonomous vehicles.

### BACKGROUND OF THE INVENTION

The use of autonomous vehicles has become increasingly prevalent in recent years. One challenge faced by autonomous vehicles is the development of systems that provide relatively fast and accurate detection and classification of street signs in an environment for navigation of autonomous vehicles that complies with requirements indicated by the street signs. Some aspects of known methods and systems have associated shortcomings. The shortcomings generally include relatively high computational intensity, low speed, and low accuracy. Accordingly, improved systems and methods for detection and classification of street signs are needed.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomy computing system of an autonomous vehicle is provided. The autonomy computing system includes at least one processor in communication with at least one memory device, the at least one processor programmed to receive, from at least one first sensor, first sensor data. The at least one processor is further programmed to detect at least one region of interest (ROI) based on the first sensor data, where the at least one ROI includes a street sign. Detecting the at least one ROI includes comparing measured dimensions of the at least one ROI to predefined dimensions of the street sign at a depth corresponding to the at least one ROI. The at least one processor is further programmed to extract ROI data of the at least one ROI from the first sensor data, and classify the street sign based on the ROI data.

In another aspect, a computer-implemented method for a sign detection and manipulation of an autonomous vehicle is provided. The computer-implemented method of sign detection includes receiving, from at least one first sensor, first sensor data and detecting at least one region of interest (ROI) based on the first sensor data, where the at least one ROI includes a street sign. The method further includes extracting ROI data of the at least one ROI from the first sensor data and classifying, using a classification machine learning model, the street sign based on the ROI data, where the classification machine learning model is configured to output a sign type and a sign value of the street sign.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle, where the autonomous vehicle includes a sign detection and classification module;

FIG. 3A is a block diagram of an example sign detection and classification module of FIG. 2; and

FIG. 3B is an embodiment of the sign detection and classification module of FIG. 3A;

FIG. 3C is another embodiment of the sign detection and classification module of FIG. 3A;

FIG. 4 is a block diagram of an example training process for machine learning models of the sign detection and classification module shown in FIG. 2;

FIG. 5 is a flowchart showing an example method of sign detection and classification;

FIG. 6A is a schematic diagram of an example neural network model;

FIG. 6B is a schematic diagram of a neuron in the example neural network model shown in FIG. 6A; and

FIG. 7 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

An autonomous vehicle needs to process large quantities of image and sensor data to determine the layout of the surrounding environment and detect objects in the environment, such as other cars, street signs, and lane lines. Notably, detection of street signs is a high priority for ensuring road rules, speed limits, and navigation markers are being observed by the autonomous vehicle.

In at least some known methods for sign detection and classification, an entire image is received and all pixels of an image is searched for features. Each feature is individually processed to determine whether or not the feature matches a sign. This approach is computationally intensive, as the approach requires processing the entire image, identifying every feature in the image, and then detecting whether the image includes signs with a high confidence. Such requirements place a burden on the limited computation resources on the autonomous vehicle.

In at least one known method for sign detection and classification, street signs are detected in a sign detector based on sensor data. Then, the detected signs are classified via separate machine learning classifiers for a specific sign type and another separate machine learning classifier/detector for detecting the text and symbol on the sign. Before routing to a specific classifier, the sign detector predicts the properties of the sign. Based on the properties, a specific classifier is selected to classify the sign, adding complexity to the detector. Use of multiple, separate machine learning models for classification increases design complexity of machine learning models, and computational and memory requirements from the detectors and the classifiers on the computing devices of the autonomous vehicle.

In contrast, in the systems and methods described herein, a sign detection and classification module of an autonomy computing system of the autonomous vehicle processes sensor data, extracts regions of interest containing signs, and classifies the street signs based on the regions of interest. Detection is specialized to signs using one or more known sign properties to inform the detection. For example, when using a LiDAR sensor, a sign will appear “bright” in the LiDAR data, as signs are made of retroreflective material. In stereo image data, known dimensions and shapes of signs may be used to identify signs at a given depth. A detection module outputs detected regions of interest, reducing computational load for the detection module and the classification module. Detection based on stereo images also has increased range of detection compared to other detection methods. Identifying signs based on regions of interest simplifies the detection process and reduces computation load, compared to analyzing every feature present in the received sensor data. A unified classification module classifies the region of interest and outputs sign type and sign text/symbol by one single neural network model. Compared to the known method of using multiple, separate classifiers to classify signs and detect sign texts/symbols, using a single, unified classification module is advantageous in reducing design complexity and improves performance, where the extra processes or functions in the detectors for detecting properties of signs and the need for designing a separate machine learning model to detect sign texts/symbols are eliminated.

Classification and detection modules may be implemented using lightweight neural network models to improve speed. A lightweight neural network model has a relatively small number of sizes, such as a relatively small number of neurons and/or a relatively small number of layers or levels. Computationally intensive networks are not needed due to the specificity of information being detected and processed and search space is reduced through detection and extraction of regions of interest. The neural network models are trained for specific purposes of detecting and/or classifying street signs. As a result, the neural network models may be relatively small and/or have relatively low levels, which have an increased computation speed and a reduced demand on memory and computation power and do not need a large training dataset to achieve increased accuracy. In training a machine learning model, training data are typically limited and require relatively large computation resources in terms of memory and computation power. Systems and methods described herein are advantageous in solving this problem by using synthetic data or synthetic data with real world data as training data for training. Synthetic data may include images of street signs and/or manipulated images of street signs, both of which are readily available or synthesized. Images of street signs may undergo image manipulation to improve detection and classification in a multitude of environments. For example, noise addition assists the models' accuracy in noisy applications, such as during a rainstorm. Color and brightness manipulation improves accuracy for various lighting environments, such as sunsets, overcast weather, or nighttime operation. Image manipulation of image distortion improves accuracy for conditions where received sensor data may be distorted. Systems and methods described herein are advantageous in improving accuracy, speed, efficiency while reducing computational load in detecting and classifying signs.

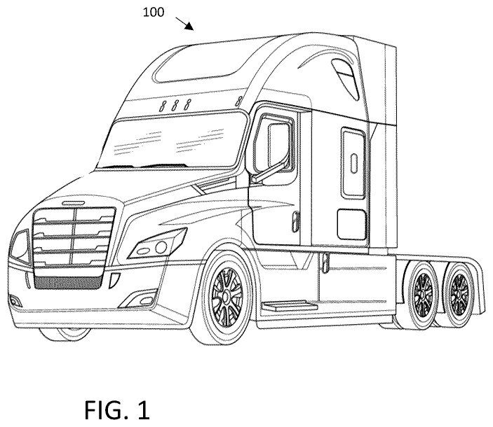

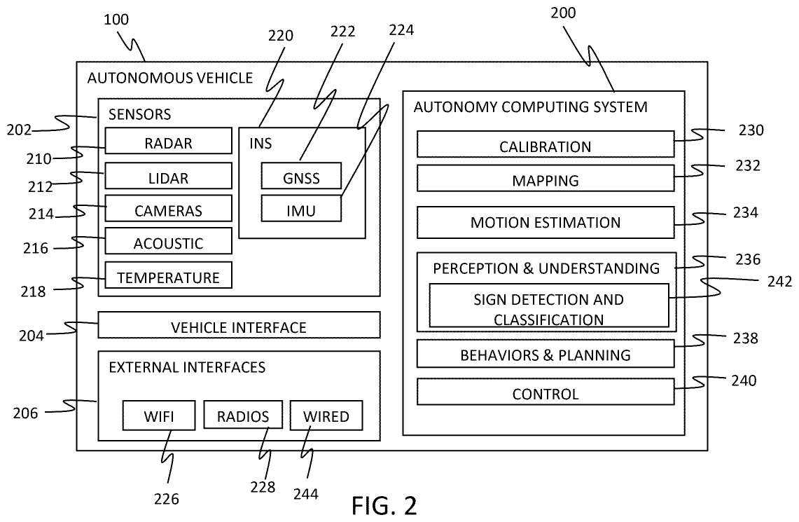

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operation of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and sign detection and classification module 242. Sign detection and classification module 242, for example, may be embodied within another module, such as perception and understanding module 236, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Sign detection and classification module 242 detects and classifies street signs. Sign detection and classification module 242 receives, for example, sensor data such as stereo camera images or LiDAR point clouds and detects one or more regions of interest that may contain street signs. The detected regions of interest are passed to an extraction module. The extraction module extracts, such as by cropping out, the regions of interest from the sensor data. Sign detection and classification module 242 then classifies streets signs in the regions of interest. Sign detection and classification module may output a sign type and a sign value of the street sign.

In some embodiments, sign detection and classification module 242 may be implemented as separate modules. For example, sign detection and classification module 242 includes a sign detection module and a sign classification module that are separate from one another.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

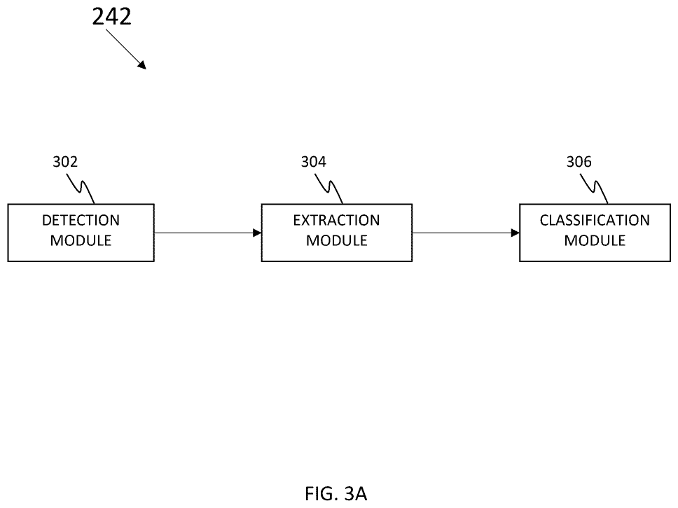

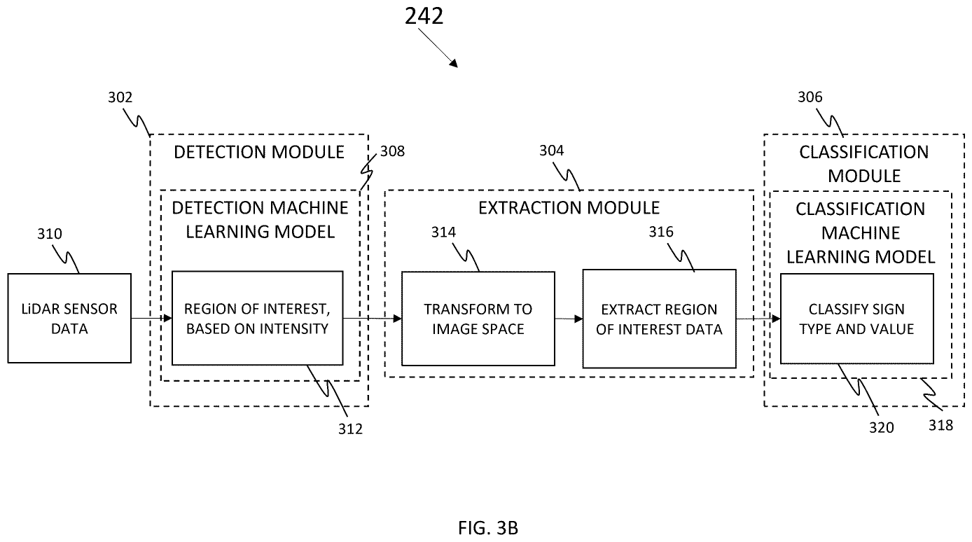

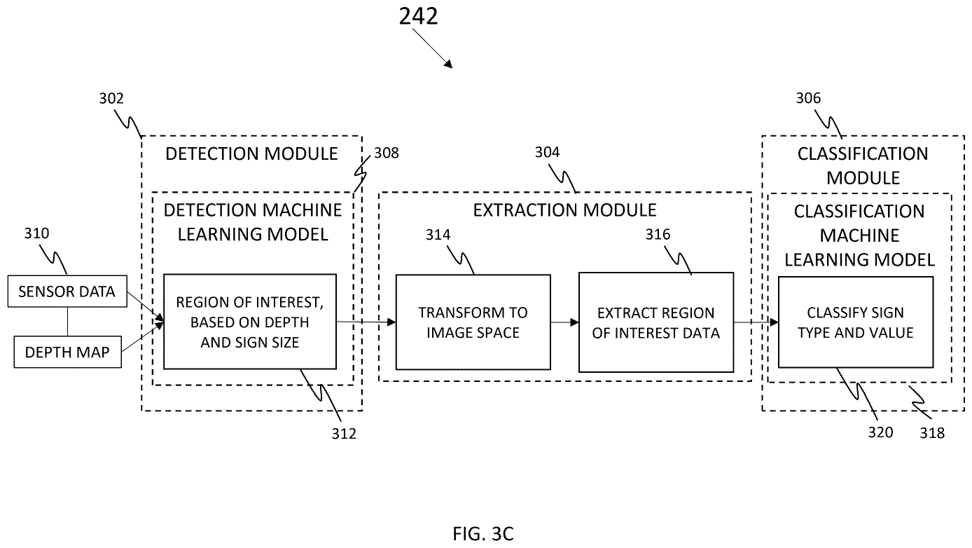

FIG. 3A is a schematic diagram of an example sign detection and classification module 242. FIG. 3B shows a schematic diagram of an embodiment of sign detection and classification module 242 of FIG. 3A, where LiDAR data are used for detection and classification. FIG. 3C shows a schematic diagram of another embodiment of sign detection and classification module 242 of FIG. 3A, where sensor data from sensors, such as stereo cameras, are used for detection and classification.

In the example embodiments, sign detection and classification module 242 includes a detection module 302. In the depicted embodiment, the sign detection and classification module 242 includes an extraction module 304 separate from detection module 302. Sign detection and classification module 242 further includes a classification module 306. Detection module 302 receives sensor data and identifies regions of interest. Extraction module 304 transforms and extracts regions of interest. Classification module 306 determines a sign type and value for detected regions of interest. In some embodiments, sign detection and classification module 242 may be arranged differently, such that modules may perform differing functions, perform functions in differing orders, or modules may be combined or further separated. For example, detection and extraction may be combined into a single module.

In the example embodiments, detection module 302 includes a detection machine learning model 308. Detection module 302 receives, from at least one sensor, at least one sensor data 310. Detection module 302 detects at least one region of interest 312 based on sensor data 310, where region of interest 312 includes a street sign. Detection module 302 outputs region of interest 312, for example, by sending region of interest 312 to extraction module 304.

Sensor data 310 includes, for example, LiDAR data, camera data such as stereo camera data, or other sensor data. LiDAR data may include a point-cloud representation of received LiDAR data. Image data is stored or converted to an hue-saturation-value (HSV) color space to separate color (hue) from brightness (value), increasing ease in manipulation of colors independent from intensity. A texture map may be produced from a received image, for example, by applying a Laws' mask to the image. The inclusion of representation in the HSV color space and/or additional features from a texture map improves the variety of features available during training and improves accuracy of sign detection and classification. In some embodiments, detection module 302 determines a depth map based on sensor data 310. In some embodiments, detection module 302 receives depth map data corresponding to received sensor data 310, or calculates depth map data based on received sensor data 310. In some embodiments, at least one of the texture map and depth map are used in conjunction with sensor data 310 to determine region of interest 312.

In the example embodiments, detection module 302 detects at least one region of interest 312 based on sensor data 310, wherein region of interest 312 may include a street sign.

In the case of received LiDAR data, detection module 302 determines region of interest 312 based on an intensity. For example, because street signs are made of retroreflective material, the points in a received LiDAR point cloud corresponding to the street sign have a higher intensity compared to other points. Based on the intensity of points from the LiDAR data, detection module 302 detects at least one region of interest 312 that contains a street sign. Using LiDAR in detection is described as an example for illustration purposes only. Sensor data may include data from sensors of other modalities, such as infrared cameras. Intensity may also indicate temperature differences, in the case of infrared data. For example, because street signs are typically fabricated with materials, such as metal, having different thermal properties from other objects in the environment in the environment in which autonomous vehicle 100 is operating, street signs may have markedly different temperatures compared to other objects in the environment, and street signs will have different intensity than other objects in received infrared sensor data.

In the example embodiments, in the case of received stereo camera data, detection module 302 determines region of interest 312 based on at least one of a depth map and sign size. Steet signs have a predefined dimensions. At a given depth, a street sign will have predefined dimensions at that depth. Detection module 302 determines whether a sign is present in region of interest 312 by comparing measured dimensions of region of interest 312 to predefined dimensions of the street sign at a depth corresponding to region of interest 312. When the measured dimensions of region of interest 312 match the predefined dimensions of the street sign at the depth corresponding to the region of interest 312, it is likely that a street sign is present. As such, detection module 302 detects region of interest 312 that contains a street sign based on comparison of dimensions.

In the depicted embodiments, detection machine learning model 308 includes a neural network model, such as a lightweight convolutional neural network (CNN) model. Functions performed by detection module 302, including receiving sensor data and determining regions of interest, may be performed by detection machine learning model 308. In some embodiments, detection of regions of interests is rule based, which is based on properties of sensor data as described herein.

For example, at a depth of sixteen meters, a stop sign might appear to have an area of 80 pixels, while at a depth of eight meters, the same sign might appear to have an area of 160 pixels. In this example, when detection machine learning model 308 detects an object with an area of 80 pixels at a depth of sixteen meters, detection machine learning model 308 returns that area as a region of interest 312. Detection based on predefined dimensions compared to measured dimensions includes comparison based on a known area at a depth to a measured area at the depth, comparison based on at least one known size (e.g. one or more sizes of one or more sides of the sign) at a depth to at least one measured size at the depth, comparison based on a known shape and/or one or more sizes at a depth to a measured shape and/or one or more measured sizes at the depth, or any combination thereof. Detection machine learning model may be trained to learn which known sign dimensions correspond to a particular depth.

Detection based on a depth map using measured dimensions compared to predefined dimensions is lightweight and avoids the high computational load typically associated with feature detection and classification used to identify objects in sensor data. Comparing a measured dimension at a depth to a known dimension at the depth is computationally inexpensive. Detection of regions of interest based on measured dimensions and known dimensions avoids the need for computationally expensive feature classification across the entirety of received sensor data to determine which areas may contain a sign.

In some embodiments, detection is performed based on both comparison of dimensions and a measured intensity of sensor data. For example, if LiDAR data indicates a highly retroreflective region that also matches the dimensions of a sign, then there is a high likelihood that the region contains a street sign.

In some embodiments, sensor data 310 may include at least one first sensor data and at least one second sensor data. First sensor data includes, for example, LiDAR data, camera data such as stereo camera data, or other sensor data. Second sensor data includes, for example, at least one of an infrared data, camera, LiDAR data, or other sensor data. Detection module 302 may augment detection of region of interest 312 with a combination of first sensor data and second sensor data. For example, when first sensor data includes camera data and second sensor data includes infrared data, detection module 302 augments detection of region of interest 312 containing a street sign by using both camera data and infrared data in detecting at least one region of interest 312. Infrared data may be used to verify the detection based on camera data. Alternatively or additionally, infrared data may be used to locate regions of interest first and camera data are used to fine tune the detection of interest of interest.

In some embodiments, detection is further based on a relative location of region of interest 312. Relative locations that may indicate presence of street sign may include, for example, region of interest 312 being located above a road (e.g. an overhead street sign on a highway), or to the sides of the road. Likewise, it is unlikely for a street sign to be located on the roadway itself. Comparing the relative location of the sign to the autonomous vehicle 100 improves confidence of detection that region of interest 312 includes a street sign.

In the example embodiments, when region of interest 312 is detected by detection machine learning model 308, detection machine learning model 308 transmits region of interest 312 and sensor data 310 to extraction module 304. Extraction module 304 extracts region of interest (ROI) data of the regions of interest from sensor data 310. In the depicted embodiments, extraction module 304 transforms 314 sensor data 310 to an image space to create transformed sensor data in the image space that include regions of interest 312. For example, extraction module 304 transforms 314 sensor data 310 including region of interest 312 to a two-dimensional (2D) image. In another example, extraction module 304 projects sensor data 310 including region of interest 312 onto a 2D image plane, where the 2D image plane corresponds a 2D image plane in camera data, to generate 2D sensor data. For example, LiDAR or infrared data are projected onto a camera image. Transforming the sensor data into 2D image space provides the inputs that is processed by classification module 306 in the same format, regardless of the modalities of sensor data, thereby simplifying the design of classification module 306.

In the example embodiments, extraction module 304 extracts 316 at least one region of interest data from the transformed sensor data. For example, the transformed sensor data are cropped at the region of interest 312 from remaining sensor data in the 2D image space.

In some embodiments, extraction module 304 outputs ROI data as the portion of sensor data 310 at the regions of interest. Extracting may be performed on sensor data 310 directly, or may be performed on combined sensor data. To reduce computational load, extraction module 304 may extract only one type of data (e.g. only image data) from combined sensor data. For example, when extracting 316 region of interest data from combined LiDAR and camera data, only the camera data including region of interest 312 may be extracted to transmit to classification module 306.

Extracting 316 region of interest data from sensor data improves computational performance. The size of data passed from extraction module 304 to classification module 306 is dramatically reduced. Instead of the entirety of sensor data 310, only portions of sensor data 310 at regions of interest 312 or portions of transformed sensor data at regions of interest 312 are provided to classification module 306. Classification module workload is reduced by removing extraneous data from the received data to be classified.

In some embodiments, extraction module 304 is part of detection module 302. For example, the functions of extraction module 304 are performed by detection machine learning model 308 such that detection machine learning model 308 outputs region of interest data. The output region of interest data may be in 2D.

In the example embodiments, classification module 306 receives at least one extracted region of interest 312 from extraction module 304. Classification module 306 classifies 320 a street sign in the region of interest data based on the at least one extracted region of interest 312. Classifying 320 includes, for example, determining a sign type and/or sign value. A sign type indicate the type of information a sign conveys. Example sign types may include warning signs, railroad crossing signs, regulatory signs, temporary traffic control signs, guide signs, or any other types of signs. For example, sign types may be speed limits, stop signs, railroad signs, one-way signs, yield signs, and no right turn on red signs. Sign values may include, for example, a numerical value, such as a speed limit, symbols, and/or texts present on the sign. A combination of the sign type and sign value provides the autonomous vehicle with a complete picture of the sign, thereby guiding operation of the autonomous vehicle.

In the example embodiments, a classification machine learning model 318 includes a neural network model, such as a lightweight convolutional neural network model (CNN). Classification module 306 receives region of interest data from extraction module 304. Classification module 306 uses classification machine learning model 318 to classify the street sign based on the at least one region of interest data. Classifying 320 the street sign may include outputting a sign classification. Sign classification includes a sign type and a sign value. For example, classification module 306 determines that received region of interest data contains a speed limit sign having a speed limit of fifty-five miles-per-hour. Classification may take into account of one or more sign properties, including but not limited to a size and shape of the sign or symbols or text present on the sign. Text and symbols may be included as one feature used to classify 320 the sign type. In some embodiments, classifying 320 a sign may be based on comparing a measured property of a sign to a predefined known property of a sign, as described above regarding detection machine learning model 308.

In operation, in the example embodiments, detection module 302 receives sensor data 310, and may further receive second sensor data, a depth map, or a texture map to augment first sensor data. Detection module 302 identifies region of interest 312 that contains a street sign based on sensor data 310 and/or other received data. Detection may be based on one or more sign properties, including a known sign property compared to a measured sign property. Detection may be performed via detection machine learning model 308. Detection may be performed without a machine learning model, and is rule-based instead. Detection module 302 transmits region of interest 312 to extraction module 304. Extraction module 304 may transform 314 region of interest 312 onto a 2D image plane to produce transformed sensor data. Extraction module 304 then extracts 316, such as by cropping, region of interest 312 to produce extracted region of interest data. Extracted region of interest data is transmitted to classification module 306. Classification module 306 uses classification machine learning model 318 to identify sign classification for region of interest data, such as a sign type and sign value.

In some embodiments, sign detection and classification module 242 receives external data that are not acquired by autonomous vehicle 100, such as from road infrastructure or other autonomous vehicles. Received data is used to determine or correct potential false positives in detection and/or classification by sign detection and classification module 242. For example, when sign detection and classification module 242 determines a sign classification with a relatively low confidence level, received data from road infrastructure or other vehicles is used to cross-check the detection and/or classification. If the received data indicates different results of detection and/or classification, the results from sign detection and classification module 242 are determined to be false positives.

In some embodiments, sign detection and classification module 242 is in operative communication with a database containing detection and classification data from other autonomous vehicles that have detected objects along the route previously. Data from other vehicles that have relatively high confidence levels in the detection and/or classification are used to cross-check the outputs by sign detection and classification module 242 that have a relatively low confidence level. Determination and classification of signs by sign detection and classification module 242 is based on both sensor data of autonomous vehicle 100 and associated values obtained from prior detections by other vehicles in the database. In one example, data from the database is fused with data obtained by sign detection and classification module 242 to determine a sign classification.

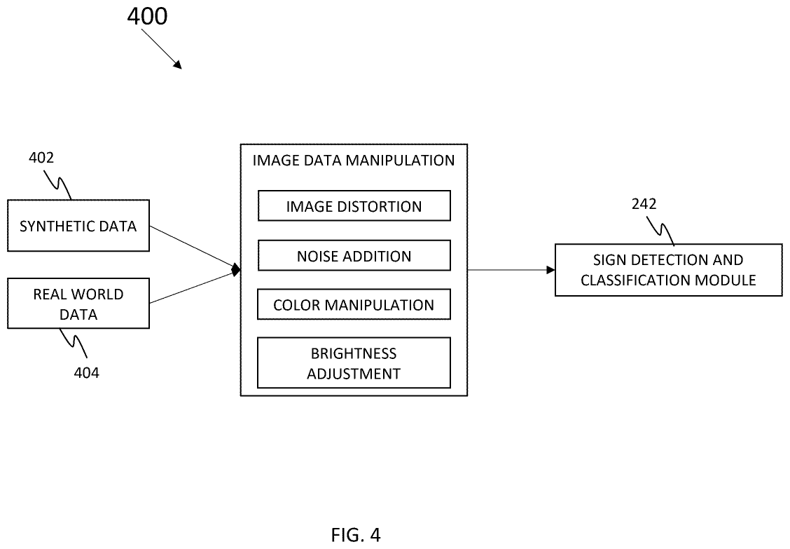

Referring now to FIG. 4, in the example embodiment, classification machine learning model and/or detection machine learning model are trained with synthetic data 402. In some embodiments, training data further includes real world data 404. Combinations of synthetic and real world training data improve accuracy and performance. Real world data 404 improves accuracy and speed in a variety of real-world applications. The inclusion of synthetic data 402 improves accuracy and speed by allowing control over the scenarios learned by machine learning models. Synthetic data 402 may include, for example, manipulated images of street signs, including at least one of image distortion, noise addition, intensity manipulation, or color manipulation. Image manipulation performed on training data improves performance, speed, and accuracy of the machine learning models. For example, noise addition may be used to improve accuracy in both normal environments and in noisy applications, such as during a rainstorm. Color and brightness manipulation may be used to improve accuracy for various lighting environments, such as sunsets, overcast weather, or nighttime operation. Image distortion may be used to improve accuracy for wide angle sensors or in other conditions where received sensor data may be distorted. Systems and methods described herein are advantageous in providing accuracy and speed while reducing computational load in detecting and classifying signs. Image manipulation may be performed on synthetic data 402, real world data 404, a subset of either data, or a combination thereof. In some embodiments, training data may include a mix of synthetic data 402 and real world data 404, because a mix of real and synthetic improves the speed and accuracy of classification.

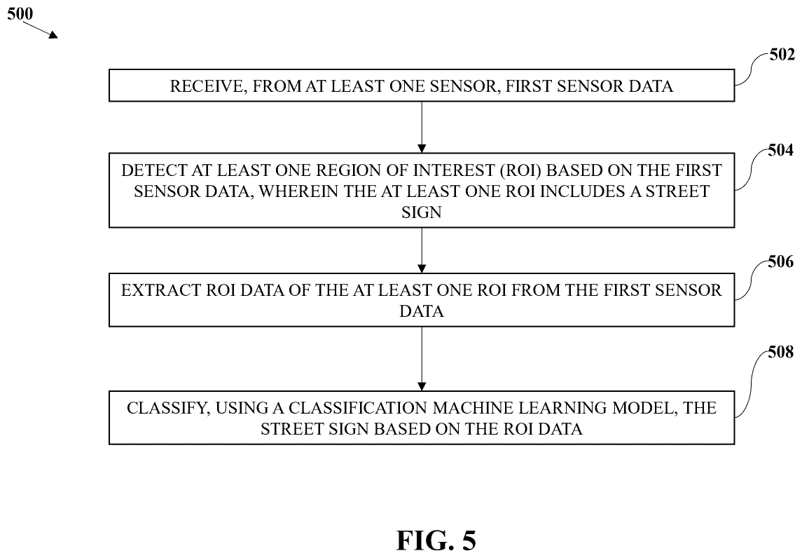

FIG. 5 shows an example method 500 of sign detection and classification. Method 500 may include receiving 502, from at least one sensor, sensor data. Method 500 may include detecting 504 at least one region of interest based on the first sensor data, wherein the at least one region of interest includes a street sign. Detecting 504 may include detecting the at least one ROI by comparing measured dimensions of the at least one region of interest to predefined dimensions of the street sign at a depth corresponding to the at least one region of interest. Detecting 504 may include detecting at least one region of interest based on an intensity associated with the sensor data. Detecting may including detecting at least one region of interest based on a combination of measured dimensions and intensity of the at least one region of interest. Method 500 may include extracting 506 region of interest data of the at least one region of interest from the sensor data. Method 500 may include classifying 508 the street sign based on the region of interest data. Classifying 508 may include classifying, using a classification machine learning model, the street sign based on the region of interest data, where the classification machine learning model is configured to output a sign type and a sign value of the street sign.

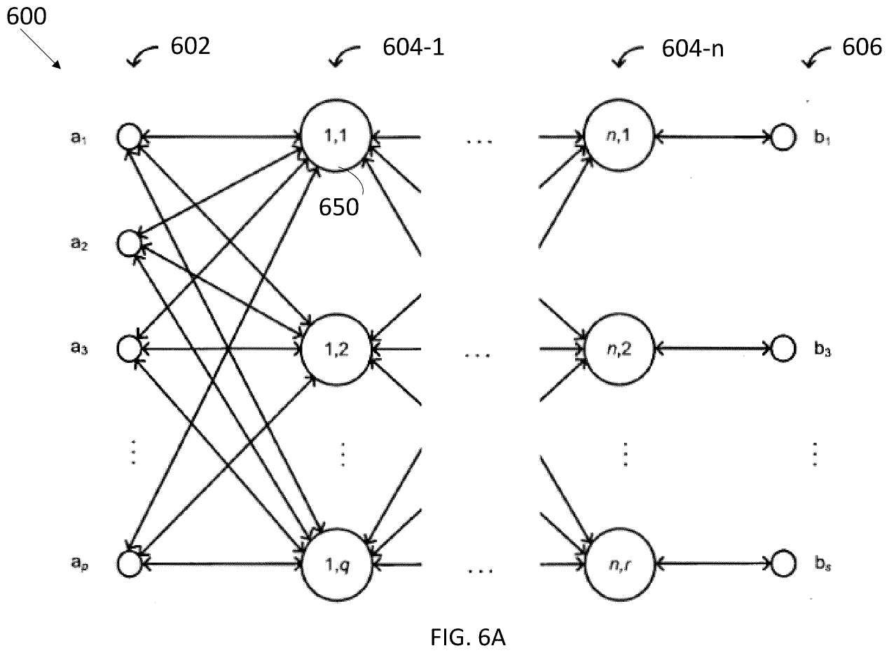

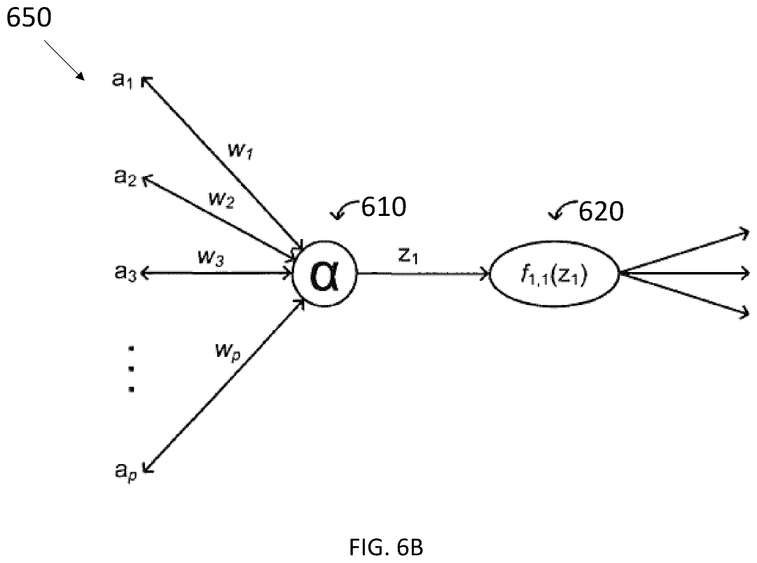

FIG. 6A depicts an example artificial neural network model 600. Detection machine learning model 308 and/or classification machine learning model 318 may be implemented as neural network model 600. The example neural network model 600 includes layers of neurons 602, 604-1 to 604-n, and 606, including an input layer 602, one or more hidden layers 604-1 through 604-n, and an output layer 606. Each layer may include any number of neurons, i.e., q, r, and n in FIG. 5A may be any positive integer. It should be understood that neural networks of a different structure and configuration from that depicted in FIG. 5A may be used to achieve the methods and systems described herein.

In the example embodiment, input layer 602 may receive different input data. For example, input layer 602 includes a first input a₁ representing training images, a second input a₂ representing patterns identified in the training images, a third input a₃ representing edges of the training images, and so on. Input layer 602 may include thousands or more inputs. In some embodiments, the number of elements used by neural network model 600 changes during the training process, and some neurons are bypassed or ignored if, for example, during execution of the neural network, they are determined to be of less relevance.

In the example embodiment, each neuron in hidden layer(s) 604-1 through 604-n processes one or more inputs from input layer 602, and/or one or more outputs from neurons in one of the previous hidden layers, to generate a decision or output. Output layer 606 includes one or more outputs each indicating a label, confidence factor, weight describing the inputs, and/or an output image. In some embodiments, however, outputs of neural network model 600 are obtained from a hidden layer 604-1 through 604-n in addition to, or in place of, output(s) from output layer(s) 606.

In some embodiments, each layer has a discrete, recognizable function with respect to input data. For example, if n is equal to 3, a first layer analyzes the first dimension of the inputs, a second layer the second dimension, and the final layer the third dimension of the inputs. Dimensions may correspond to aspects considered strongly determinative, then those considered of intermediate importance, and finally those of less relevance.

In other embodiments, the layers are not clearly delineated in terms of the functionality they perform. For example, two or more of hidden layers 604-1 through 604-n may share decisions relating to labeling, with no single layer making an independent decision as to labeling.

FIG. 6B depicts an example neuron 650 that corresponds to the neuron labeled as “1,1” in hidden layer 604-1 of FIG. 5A, according to one embodiment. Each of the inputs to neuron 650 (e.g., the inputs in input layer 602 in FIG. 5A) is weighted such that input a₁ through aₚ corresponds to weights w₁ through wₚ as determined during the training process of neural network model 600.

In some embodiments, some inputs lack an explicit weight, or have a weight below a threshold. The weights are applied to a function α (labeled by a reference numeral 610), which may be a summation and may produce a value z₁ which is input to a function 620, labeled as f_{1,1}(z₁). Function 620 is any suitable linear or non-linear function. As depicted in FIG. 6B, function 620 produces multiple outputs, which may be provided to neuron(s) of a subsequent layer or used as an output of neural network model 600. For example, the outputs may correspond to index values of a list of labels or may be calculated values used as inputs to subsequent functions.

It should be appreciated that the structure and function of neural network model 600 and neuron 650 depicted are for illustration purposes only, and that other suitable configurations exist. For example, the output of any given neuron may depend not only on values determined by past neurons, but also on future neurons.

Neural network model 600 may include a convolutional neural network (CNN), a deep learning neural network, a reinforced or reinforcement learning module or program, or a combined learning module or program that learns in two or more fields or areas of interest. Supervised and unsupervised machine learning techniques may be used. In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. Neural network model 600 may be trained using unsupervised machine learning programs. In unsupervised machine learning, the processing element may be required to find its own structure in unlabeled example inputs. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics, and information. The machine learning programs may use deep learning algorithms that may be primarily focused on pattern recognition, and may be trained after processing multiple examples. The machine learning programs may include Bayesian Program Learning (BPL), voice recognition and synthesis, image or object recognition, optical character recognition, and/or natural language processing—either individually or in combination. The machine learning programs may also include natural language processing, semantic analysis, automatic reasoning, and/or machine learning.

Based upon these analyses, neural network model 600 may learn how to identify characteristics and patterns that may then be applied to analyzing image data, model data, and/or other data. For example, neural network model 600 may learn to identify features in a series of data points.

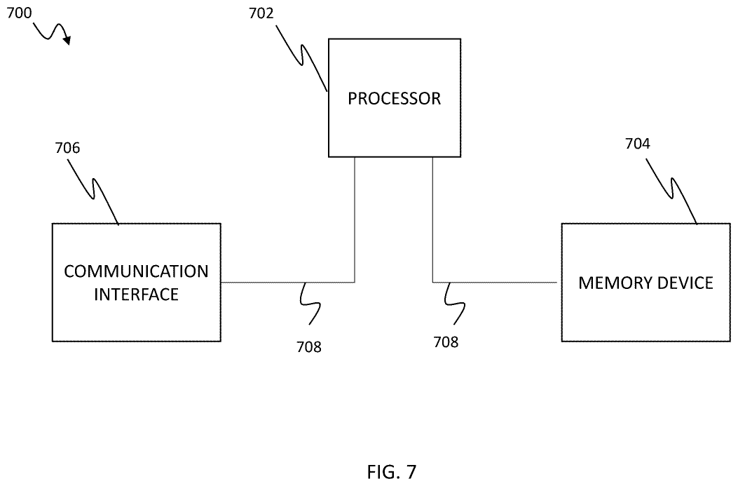

FIG. 7 is a block diagram of an example computing device 700. Autonomy computing system 200 and/or sign detection and classification module 242 may be implemented with one or more computing devices 700. Computing device 700 includes a processor 702 and a memory device 704. Memory device 704 may include a non-transitory machine-readable storage media. Processor 702 is coupled to memory device 704 via a system bus 708. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, memory device 704 includes one or more devices that enable information, such as executable instructions or other data (e.g., sensor data), to be stored and retrieved. Moreover, memory device 704 includes one or more computer readable media, such as, without limitation, dynamic random access memory (DRAM), static random access memory (SRAM), a solid state disk, or a hard disk. In the example embodiment, the memory device 704 stores, without limitation, application source code, application object code, configuration data, additional input events, application states, assertion statements, validation results, or any other type of data. Computing device 700, in the example embodiment, may also include a communication interface 706 that is coupled to processor 702 via system bus 708. Moreover, communication interface 706 is communicatively coupled to data acquisition devices.

In the example embodiment, processor 702 may be programmed by encoding an operation using one or more executable instructions and providing the executable instructions in memory device 704. In the example embodiment, processor 702 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) improving accuracy and speed of sign detection and classification by using a depth map in combination with sensor data, (b) improving accuracy and speed of sign classification by extracting only a region of interest 312 associated with a detected street sign for classification, or (c) improving accuracy and speed of sign detection and classification by combining real and synthetic image manipulation training data for at least one neural network model.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample (e.g., training) data sets or certain data into the programs, such as conversation data of spoken conversations to be analyzed, mobile device data, and/or additional speech data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In one embodiment, machine learning techniques may be used to extract data about the conversation, statement, utterance, spoken word, typed word, geolocation data, and/or other data.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An autonomy computing system of an autonomous vehicle, the autonomy computing system comprising at least one processor in communication with at least one memory device, the at least one processor programmed to:
receive, from at least one first sensor, first sensor data;
detect at least one region of interest (ROI) based on the first sensor data, wherein the at least one ROI includes a street sign, the at least one processor further programmed to:
detect the at least one ROI by comparing measured dimensions of the at least one ROI to predefined dimensions of the street sign at a depth corresponding to the at least one ROI;
extract ROI data of the at least one ROI from the first sensor data; and
classify the street sign based on the ROI data.

2. The autonomy computing system of claim 1, wherein the at least one processor is further programmed to:
classify, using a classification machine learning model, the street sign based on the ROI data.

3. The autonomy computing system of claim 2, wherein the at least one processor is further programmed to:
classify, using the classification machine learning model, a sign type and a sign value of the street sign, wherein the sign type and the sign value are outputs from the classification machine learning model.

4. The autonomy computing system of claim 2, wherein the at least one processor is further programmed to:
train the classification machine learning model using training data, the training data including synthetic data.

5. The autonomy computing system of claim 4, wherein the synthetic data includes manipulated images of street signs, image manipulation of images of the street signs including at least one of image distortion, noise addition, intensity manipulation, or color manipulation.

6. The autonomy computing system of claim 1, wherein the at least one processor is further programmed to:
detect, using a detection machine learning model, the at least one ROI.

7. The autonomy computing system of claim 1, wherein the at least one processor is further programmed to:
extract the ROI data by:
transforming the first sensor data to a two-dimensional (2D) image; and
extracting the ROI data by cropping the 2D image at the at least one ROI.

8. The autonomy computing system of claim 1, wherein the at least one first sensor includes a stereo camera, the at least one processor further programmed to:
detect the at least one ROI by:
determining a depth map based on the first sensor data; and
detect the at least one ROI based on the depth map.

9. The autonomy computing system of claim 1, wherein the at least one processor is further programmed to:
receive, from at least one second sensor, second sensor data, the at least one second sensor including at least one of an infrared sensor or a Light Detection and Ranging (LiDAR) sensor; and
augment detection of the at least one ROI with the second sensor data.

10. A computer-implemented method of sign detection and classification for an autonomous vehicle, the method comprising:
receiving, from at least one first sensor, first sensor data;
detecting at least one region of interest (ROI) based on the first sensor data, wherein the at least one ROI includes a street sign;
extracting ROI data of the at least one ROI from the first sensor data; and
classifying, using a classification machine learning model, the street sign based on the ROI data, wherein the classification machine learning model is configured to output a sign type and a sign value of the street sign.

11. The method claim 10, further comprising:
detecting the at least one ROI by comparing measured dimensions of the at least one ROI to predefined dimensions of the street sign at a depth corresponding to the at least one ROI.

12. The method of claim 11, further comprising:
classifying, using the classification machine learning model, a sign type and a sign value of the street sign, wherein the sign type and the sign value are outputs from the classification machine learning model.

13. The method of claim 11, further comprising:
training the classification machine learning model using training data, the training data including synthetic data.

14. The method of claim 13, further comprising:
training the classification machine learning model by:
training based on training data including manipulated images of street signs, image manipulation of images of the street signs including at least one of image distortion, noise addition, intensity manipulation, or color manipulation.

15. The method of claim 10, further comprising:
detecting, using a detection machine learning model, the at least one ROI.

16. The method of claim 10, further comprising:
detecting the at least one ROI by:
determining a depth map based on the first sensor data; and
detecting the at least one ROI based on the depth map.

17. The method of claim 10, further comprising:
receiving, from at least one second sensor, second sensor data, the at least one second sensor including at least one of an infrared sensor or a Light Detection and Ranging (LiDAR) sensor; and
augmenting detection of the at least one ROI with the second sensor data.

18. The method of claim 10, further comprising:
detecting the at least one ROI based on at least one of a texture map or a hue-saturation-value (HSV) color space representation of the first sensor data.

19. The method of claim 10, further comprising:
receiving LiDAR data from the at least one first sensor; and
detecting the at least one ROI based on LiDAR data.

20. The method of claim 10 further comprising:
reducing false positives in detection and/or classification based on external data.
